(19) United States
(12) Patent Application Publication
(10) Pub. No.: US 2008/0193601 A1
(43) Pub. Date: Aug. 14, 2008

(54) Protein-containing beverage and method of manufacture

(76) Inventor: Faik A. Nasser, Canton, MI (US)

Correspondence Address: THE WEINTRAUB GROUP, P.L.C., Suite 240, 32000 Northwestern Highway, Farmington Hills, MI, 48334, US

(21) Appl. No.: 12/069,255

(22) Filed: Feb. 8, 2008

Related U.S. Application Data
(60) Provisional application No. 60/900,439, filed on Feb. 10, 2007.

(51) Int. Cl. A23L 2/66; A23L 2/60; A23L 2/56; A23F 3/00; C11B 5/00; A23L 3/16

(52) U.S. Cl. 426/72; 426/590; 426/597; 426/542

(57) ABSTRACT

A protein-containing beverage is provided by the inclusion of an acidified whey aqueous solution therewith. A sport drink is prepared by admixing the acidified whey aqueous solution with an aqueous tea solution. With nutritional supplements added to the sport drink, an energy drink is obtained. The preferred tea is a green tea. Adjuvants such as sweeteners, supplemental antioxidants, preservatives, vitamins, caffeine and carbonated water may be incorporated into the beverage hereof

### CROSS REFERENCE TO RELATED APPLICATIONS

This application is a completion application of co-pending U.S. provisional patent application Ser. No. 60/900,439, filed Feb. 10, 2007 “Protein-Containing Beverage and Method of Manufacture”, the entire disclosure of which is hereby incorporated by reference.

### BACKGROUND OF THE INVENTION

1. Field of the Invention

The present invention pertains to beverages. More particularly, this invention relates to a pre-packaged protein-containing beverage. Even more particularly, the present invention concerns pre-packaged protein-containing tea-based beverages and methods of manufacture.

2. Prior Art

As is known to those skilled in the art to which the present invention pertains, pre-packaged bottled beverages have become quite popular. These bottled beverages are marketed in various flavors, some sugar-containing and some with artificial sweeteners. Oftentimes, these beverages are tea-based beverages. With a tea-based beverage, the tea itself, which is an antioxidant, is ordinarily supplemented with at least one additional antioxidant, as well as with preservatives, flavorants and a food grade acid (GRAS) such as phosphoric acid, citric acid or the like.

However, what is readily apparent is that none of these tea-based beverages contain protein or a source of protein thereby precluding the utilization of these tea-based beverages as a “sport drink”. Because of the nature of the tea-based beverage, itself, and whey as a protein source, attempts to incorporate whey protein therein fails because the protein precipitates out of solution.

As is subsequently detailed, the present invention addresses this issue by providing modified whey, as a protein source, which can be incorporated into a tea-based beverage and a method of manufacture therefor.

### SUMMARY OF THE INVENTION

In accordance with the present invention there is provided an acidified whey which is used as a protein source in various beverages.

The acidified whey is prepared by dissolving a powdered whey in acidified water. In acidifying the whey, food grade acids or GRAS rated acids are utilized. Amongst the useful acids are phosphoric acid, citric acid and mixtures thereof. The acid is utilized in an amount sufficient to maintain the pH of the aqueous solution at a pH less than pH 3.0.

Acidification takes place at ambient conditions with gentle agitation to avoid aeration of the solution.

The so-acidified whey is water-soluble and can be readily admixed with various aqueous-based beverages, including tea and flavored waters.

Additionally, when incorporated into a tea a “sport drink” is thereby defined.

The sport drink may then have suitable adjuvants incorporated therewith to prepare an energy drink therefrom.

For a more detailed description of the present invention reference is made to the following detailed description and accompanying example

### DETAILED DESCRIPTION OF THE PREFERRED EMBODIMENT

In accordance herewith, it had been found that by acidifying whey, in an aqueous medium, it is possible to incorporate the whey, as a source of protein, into an aqueous-based beverage. Preferably, the whey is incorporated into a tea to provide a sport drink.

Specifically, it has now been found that by acidifying and extracting whey in an aqueous medium there is provided a protein source which is soluble in aqueous solutions and which can be incorporated into a tea-based beverage to define a sport-drink.

More specifically, it has now been found that an acidic extract of whey is readily soluble in an aqueous solution and is storage stable over an extended period of time.

When this acidified whey solution is mixed with an aqueous beverage, and, in particular, a solution of tea there is obtained a protein-containing tea-based sport drink.

The acidifying process contemplated for use herein generally, comprises dissolving a powdered whey in acidified water to thereby acidify the whey. In acidifying the whey, food grade acids or GRAS acids are utilized.

The aqueous solution from which the whey is prepared is acidified with one or more acids selected from the group consisting of food grade phosphoric acid, food grade citric acid and mixtures thereof Preferably, a mixture of the phosphoric and citric acid is used. Where a mixture of acids are used, they are employed in a volumetric ratio of about 3:1 of citric to phosphoric.

The acid is utilized in an amount sufficient to maintain the pH of the acidified water at a pH less than pH 3.0. Preferably, the pH will range between about pH 2.80 to pH 2.90. The acidification takes place at ambient conditions with gentle agitation to avoid aeration of the solution.

In accordance with the present invention, a commercially available source of whey, preferably, an acidic whey is added to the at least one acid-containing water. Preferably, the whey itself is a powdered whey having a pH of between pH 3.2 and pH 3.6. This type of whey is well known and commercially available such as that sold by Glanbia Nutritionals under the trademark Provon A-190.

Preferably, distilled water is used in the acidifying process

In carrying out the production process for the whey, the whey is present in an amount ranging from about 1.0 to about 30 parts, by weight, per gallon of acidified water. Preferably, the whey is present in an amount ranging from about 2.3 parts to about 22 parts, by weight, per gallon of acidified water.

The acidified water is prepared at ambient conditions adding the acid to the water until the pH reaches about pH 2.8 to about pH 2.9. Thereafter, the whey is added thereto in the specified amounts at ambient conditions and with gentle agitation. The mixture is then stirred to dissolve the whey, in the acidified water while continuing to add acid, if necessary, to maintain the pH below pH 3.0.

The so-acidified whey is in solution and is usable as an aqueous solution thereof. The acidified whey can then be admixed with various beverages including, for example, flavored water, sodas, teas, and the like.

In a particularly preferred embodiment, there is provided a tea-based beverage which comprises an effective amount of the acidified whey hereof.

The tea used herein and which is admixed with the whey solution comprises an aqueous solution of tea. The tea solution may be used as is or may have adjuvants incorporated therewith. Suitable adjuvants include, for example, natural sweeteners, such as honey, sugar and the like as well as mixtures thereof. Similarly, artificial sweeteners can be used as well. Additional antioxidant sources such as grape skin, grape juice, aronia, as well as ginseng and the like may be used herein in suitable effective amounts, as well as mixtures thereof.

The tea, itself, may be any of the well-known teas such as green tea, oolong tea, orange tea, Ceylon tea, black tea and the like, as well as mixtures thereof.

The aqueous tea solution is prepared by either using a tea extract or by boiling tea leaves in water for a sufficient period of time, usually 5 to 10 minutes and, thereafter, filtering the solution to remove the tea leaves therefrom, alternatively, the tea may be prepared by steeping the leaves in the boiling water. Preferably, a tea extract is used to prepare the sport drink.

Generally, about 10 to about 50 pounds of liquid tea extract per 1000 gallons of water are used to prepare the tea solution.

The sweetener, where used, will ordinarily be present in an amount ranging from about 200 grams to about 500 grams thereof per gallon of tea solution. This is directly dependent on the type of sweetener used and may be varied to adjust for taste. Artificial sweeteners are, ordinarily, used in the lower end of the range.

The additional antioxidants, where used, will be present in an amount ranging from about 10 parts to about 100 parts thereof, per gallon of tea solution.

Preservatives, such as, for example, potassium sorbate, sodium benzoate, sodium citrate and the like as well as mixtures thereof may also be added to the tea mixture in effective amounts.

In the practice of the present invention, a preferred tea solution for admixture with the whey extract comprises green tea, grape skin extract, aronia, and honey, preferably, without preservatives.

To prepare the sport drink, the two separate solutions are mixed together while maintaining the pH at less than pH 3.0. The two batches are mixed together with stirring and at ambient conditions. Once mixed, the so-produced beverage is then pasteurized at suitable temperature and pressure for a sufficient period of time to provide the tea-based sport drink. It should be noted that in addition to pasteurizing the beverage, aseptic packaging may be used wherein the bottles are sterilized, filled and sealed under sterile conditions to eliminate the need for refrigeration.

The resulting sport drink product contains from about 0.5 gram to about 1.0 grams of protein per 500 milliliters or more of beverage. Preferably, the resulting beverage does not exceed 30.0 grams of protein per gallon of fluid.

The sport drink hereof may be fortified to provide an “energy drink”. To prepare an energy drink, nutritional supplements such as vitamins, the additional antioxidants, referred to above such as grape skin or grape skin extract, additional sugars, caffeine and the like, will be added to the sport drink. Furthermore, in preparing an energy drink in accordance herewith carbonated water may be used along with taurine, inositol, a milk acid such as lactic and/or tartaric acid, acid salts such as sodium and potassium citrate, flavorants, colorants and the like being added thereto in effective amounts.

Among the useful vitamins are, for example, Vitamin B-12, Vitamin B-6, niacin, riboflavin, folic acid, Vitamin C and the like. Similarly, other food grade or GRAS acids may be added to the tea solution such as malic acid.

Useful natural sugars used herein including, for example, dextrose, sucrose, glucose and the like, as well as mixtures thereof. These sugars may be substituted for or used conjointly with the honey used in the sport drink. Also, minor amounts of caffeine may be added thereto as well as additional herbal supplements such as further minor amounts of aronia may be used to prepare the energy drink.

The energy drink is prepared by adding these additional ingredients to the sport drink in effective amounts at ambient conditions and with gentle stirring.

In preparing the tea solution portion of the energy drink, it is preferred that it be prepared from tea leaves in lieu of the tea extract.

The final energy drink will ordinarily contain about three grams of tea per gallon of energy drink.

For a more complete understanding reference is made to the following illustrative example of the present invention. In the example, all parts are by weight absent indications to the contrary.

### EXAMPLE

This example illustrates the preparation of a sport drink in accordance with the present invention.

Into a suitable mixing vessel equipped with stirring means is added, at room temperature and pressure, one thousand gallons of purified filtered water. To the water is added 0.1 grams per liter of a 50:50 volumetric mixture of food grade phosphoric acid and citric acid to bring the water to pH 2.85. Thereafter, 0.5 grams per liter of water of a commercially available powdered whey, sold by Glanbia Nutritionals under the name Provon A-190, is added thereto with mixing. Mixing is continued until all the whey is dissolved in the acidified water.

Into a separate batch processor is added, with stirring and at ambient temperatures and pressure, one thousand gallons of filtered water, thirty pounds of dry green tea extract, eighteen pounds of honey, one pound of grape skin extract and one pound of aronia. Once the dry powdered components are dissolved, the whey-containing solution is added to the tea solution and the two solutions are mixed together.

After mixing the two solutions together, the resulting product is pasteurized by boiling the product at 180° F. for about one minute. Thereafter the product is cooled down, then bottled aseptically, and is ready for use.

It is to be appreciated from the preceding that there has been described herein a process for manufacturing a sport drink as well as the resulting protein-containing sport drink itself.

Having thus described the invention, what is claimed is:

1. In an aqueous-based beverage composition, the improvement which comprises:
an effective amount of an aqueous solution of acidified whey as a protein source.

2. A sport drink, comprising:
(a) an aqueous tea solution,
(b) an aqueous solution of acid whey dissolved in the tea solution.

3. The sport drink of claim 2 wherein:
the tea solution includes a supplemental antioxidant selected from the group consisting of grape skin, grape juice, aronia, ginseng and mixtures thereof.

4. The sport drink of claim 3 which further includes a natural sweetener selected from the group consisting of honey, sugar and mixtures thereof;

5. The sport drink of claim 4 which further includes an effective amount of a preservative.

6. The sport drink of claim 2 which further includes at least one nutritional supplement to define an energy drink.

7. The sport drink of claim 6 wherein the nutritional supplement is selected from the group consisting of:
(a) at least one vitamin,
(b) at least one supplemental antioxidant,
(c) at least one natural sweetener,
(d) caffeine, and mixtures thereof.

8. The sport drink of claim 7 which further includes at least one adjuvant selected from the group consisting of:
(a) carbonated water,
(b) taurine,
(c) inositol,
(d) a milk acid selected from the group consisting of lactic acid, tartaric acid and mixtures thereof,
(e) an acid salt selected from the group consisting of sodium citrate, potassium citrate and mixtures thereof,
(f) a flavorant, and mixtures thereof.

9. The sport drink of claim 6 which comprises: about three grams of the tea per gallon of the entire composition.

10. The sport drink of claim 2 which comprises:
up to about thirty grams of whey per gallon of the entire drink.

11. The sport drink of claim 2 wherein:
the tea is selected from the group consisting of green tea, oolong tea, orange tea, Ceylon tea, black tea and mixtures thereof.

12. The sport drink of claim 2 wherein:
the tea is green tea.

13. The sport drink of claim 2, wherein the drink is at pH less than pH 3.0.

14. A method of producing a sport drink, comprising:
(a) preparing an aqueous solution of acidified whey,
(b) preparing an aqueous tea solution,
(c) mixing the two solutions together at ambient conditions while maintaining a pH of less than pH 3.0, and
(d) pasteurizing the resulting solution, and
(e) cooling the resulting pasteurized solution.

15. The method of claim 14 which further comprises:
aseptically packaging the pasteurized and cooled solution.

16. The method of claim 14 wherein the so-produced drink comprises:
up to about thirty grams of whey per gallon of drink, and about three grams of tea per gallon of drink.
